(19) United States
(12) Patent Application Publication
(10) Pub. No.: US 2005/0022228 A1
(43) Pub. Date: Jan. 27, 2005

(54) Digital recording-based computer testing and debugging system

(75) Inventor: Mark Perry Davis, Seattle, WA (US)

Correspondence Address: MARK P. DAVIS, 2852 SW GENESEE STREET, SEATTLE, WA, 98126, US

(73) Assignee: VideoTest LLC, Seattle, WA (US)

(21) Appl. No.: 10/624,700

(22) Filed: Jul. 21, 2003

(51) Int. Cl. H04N 7/173; H04N 7/16; H04N 5/91

(52) U.S. Cl. 725/28; 725/134; 386/46

(57) ABSTRACT

Electronic devices are tested by digitally recording an output signal from an electronic device that is being tested by a human operator. The output signal typically comprises video and/or audio information that is used by the human operator to operate the electronic device. The recorded output signal is provided to a bug database via a bug database server. The bug database server stores the recorded output signal and associates the stored signal with indexes such as time of the recording, channel of the recording, signal type, and the like. The bug database server also receives bug reports from the human operator that relate to anomalies encountered by the operator while testing the electronic device. Information from the bug report is used as a keyword for one of the associated indexes to link the bug report with a particular segment of the recorded output signal to which the bug report pertains.

### FIELD OF THE INVENTION

The present invention relates generally to the field of computer testing. More particularly, the present invention relates to the field of digital recording-based computer testing and debugging.

### BACKGROUND OF THE INVENTION

Computer hardware and software (such as game platforms and software) are desirably verified by testing before the hardware and/or software is offered for sale. The computer hardware and software is often tested as a unit to ensure that the tested unit operates according to the intended purposes of the hardware and software. In many cases, the computer hardware and software are tested by human operators in the way in which an end-user would use the unit.

For production line testing, it is typically impractical to use skilled engineers (i.e., the developers) for testing the multiplicity of production line units. Often, operators having the levels of skills of typical end-users are employed for testing the units. Operators test the unit by manipulating the unit for a period of time and either “pass” the unit or note any encountered problems (e.g., “bugs”). The operators can write a bug report that records information related to an encountered problem for the benefit of engineers who may wish to debug the encountered problem. Additionally, videotapes can be used to visually record the sequence in which the bug was encountered for the purpose of being able to reestablish the environment in which the bug was encountered.

An appreciation of the present invention and its improvements can be obtained by reference to the accompanying drawings, which are briefly summarized below, to the following detailed description of illustrated embodiments of the invention, and to the appended claims.

### BRIEF DESCRIPTION OF THE DRAWINGS

FIG. 1 is a functional block diagram of a computing device adapted to implement an embodiment of the invention;

FIG. 2 shows an overview schematic of a system for efficiently arranging data and code in computer-readable media for enhanced access times.

### DETAILED DESCRIPTION OF THE PREFERRED EMBODIMENT

The present invention is directed to a method and apparatus for digital recording-based computer testing. A digital recording server records an output signal from an electronic device that is being tested by a human operator. The output signal typically comprises video and/or audio information that is used by the human operator to operate the electronic device. The recorded output signal is provided to a bug database via a bug database server. The bug database server stores the recorded output signal and associates the stored signal with indexes such as time of the recording, channel of the recording, signal type, and the like. The bug database server also receives bug reports from the human operator that relate to anomalies encountered by the operator while testing the electronic device. Information from the bug report is used as a keyword for one of the associated indexes to link the bug report with a particular segment of the recorded output signal to which the bug report pertains.

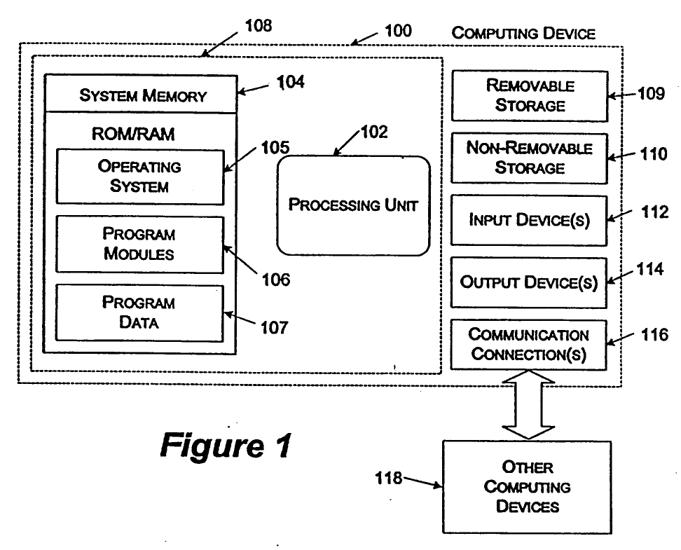

FIG. 1 is a functional block diagram of a computing device adapted to implement an embodiment of the invention. With reference to FIG. 1, an exemplary system for implementing the invention includes a computing device, such as computing device 100. In a basic configuration, computing device 100 typically includes at least one processing unit 102 and system memory 104. Depending on the exact configuration and type of computing device, system memory 104 may be volatile (such as RAM), non-volatile (such as ROM, flash memory, etc.) or some combination of the two. System memory 104 typically includes an operating system 105, one or more program modules 106, and may include program data 107. This basic configuration is illustrated in FIG. 1 by those components within dashed line 108.

Computing device 100 may also have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and nonvolatile, removable and non-removable media implemented in any method or technology for storage of information, such as computer-readable instructions, data structures, program modules or other data. System memory 104, removable storage 109 and non-removable storage 110 are all examples of computer storage media. Computer storage media includes RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of computing device 100. Computing device 100 may also have input device(s) 112 such as keyboard, mouse, pen, voice input device, touch input device, etc. Output device(s) 114 such as a display, speakers, printer, etc. may also be included. It will be appreciated that components of computing device 100 may take different forms from those described here as the level of technology improves in computer-related equipment.

Computing device 100 may also contain communications connection(s) 116 that allow the device to communicate with other computing devices 118, such as over a network. Communications connection(s) 116 is an example of communication media. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, communication media includes wired media such as a wired network or direct-wired connection, and wireless media such as acoustic, RF, infrared and other wireless media. The term computer-readable media as used herein includes both storage media and communication media.

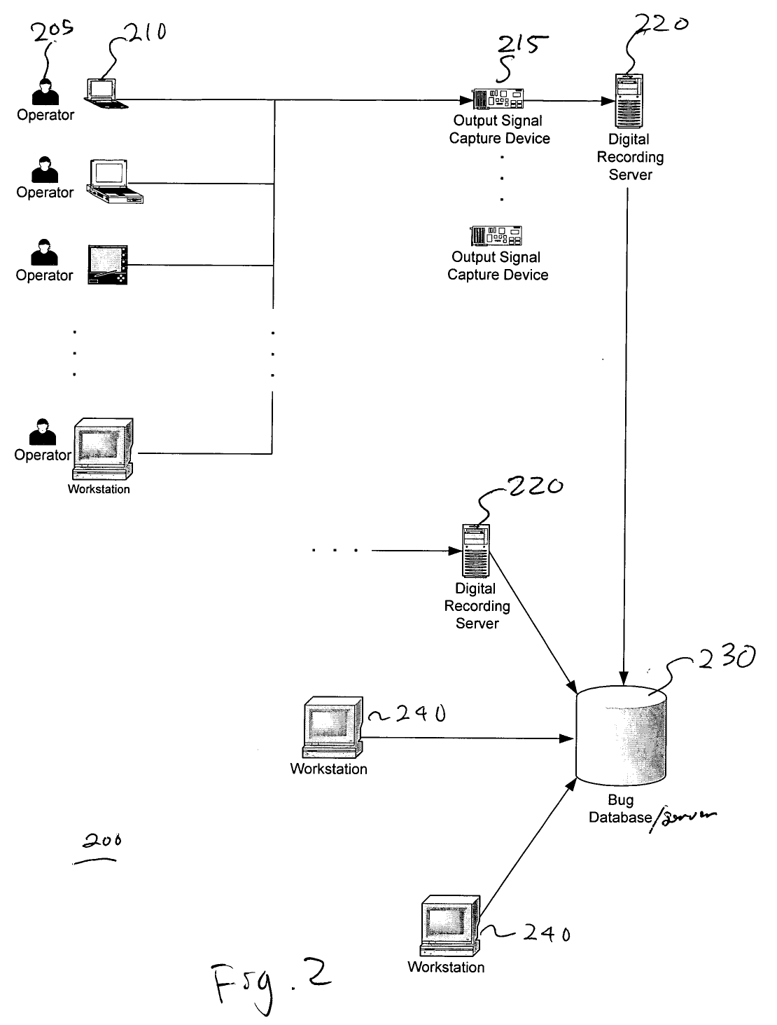

FIG. 2 is an overview schematic of a computer system for recording multimedia signals in a “bug”-recording database in accordance with the present invention. Bug database system 200 includes at least one electronic device 210, digital recording server 220, bug database server 230, and workstation 240. For simplicity, digital recording server 220, bug database server 230, and workstation 240 are shown as individual units. However, it is possible that the functionality of the individual units can be provided within a single workstation.

Electronic devices 210 typically comprise computer hardware and software for which testing is desired. Electronic devices 210 are typically units produced by an assembly line, although prototype units may also be deployed for testing. The computer software for which testing is desired may comprise applications (such as games, productivity software, and the like) or system software (such as the operating system, device drivers, and the like). The computer hardware for which testing is desired may comprise a computing device that is configured as a general-purpose computer, a game “box,” a web-“surfing” accessory, and the like. A plurality of electronic devices 210 may be tested simultaneously. The electronic devices (210) need not be of the same type while being tested simultaneously.

Electronic devices 210 (while being tested by operator 205) each provide an output signal that is recorded by digital recording server 220. The output signal typically comprises video and/or audio information that typically reflects the state of the electronic device. The output signal typically is used to drive a display (for example), which is normally used by the human operator (205) to interact with the electronic device in accordance with the intended use of the electronic device.

The output signal is also provided to digital recording server 220. Often, the output signal is directly coupled (often including using hubs and/or multiplexers) with digital recording server 220 (such as when electronic device 210 provides an output signal in a digital format such as DVI, IEEE 1394, USB, and the like).

When electronic device 210 provides an analog output signal (such as in an NTSC, PAL, or SECAM format), optional output signal capture device 215 may be used to convert the analog signal into a digital signal. When electronic device 210 does not provide a suitable electrical output signal, optional output signal capture device 215 may comprise a camera by which a visual output signal from the electronic device 210 may be converted to an electrical signal. A plurality of output signal capture devices 215 may be implemented as necessary to capture and multiplex simultaneous output signals.

Digital recording server 220 records the provided output signal (simultaneously recording multiple output signals, if necessary) and associates the recorded signal with information such as the time (and duration) of the recording, the channel or port number through which the signal is received, the signal type, or other relevant information. Digital recording server 220 typically compresses the output signal as the output signal is received, although the signal may be stored in uncompressed format. (Uncompressed recorded output signals may be compressed at a later time, such as for archival purposes). A plurality of digital recording servers 220 may be used simultaneously while testing a plurality of electronic devices 210.

Digital recording server 220 provides the recorded output signals and associated information to bug database server 230 for storage. Bug database server 230 indexes the recorded output signals with the associated information such that recorded output signals may be addressed using the associated information as keys. As discussed above, bug database server 230 may be a stand-alone device, integrated within a workstation (240), or distributed across multiple devices.

When operator (205) encounters an anomaly while testing electronic device 210, the operator notes the time in which the anomaly was encountered (or other information that is sufficient to identify the time of the anomaly). Subsequently, operator 205 prepares a bug report (using workstation 240 for example) that typically describes the nature of the anomaly, how the anomaly was encountered, and the time and machine (or channel or port number, for example).

Workstation 240 provides the bug report to bug database server 230, where information from the bug report is used to identify and address a recorded output signal that corresponds with the bug report. Bug database server 230 typically stores the provided bug report as a field within a record containing the bug report.

Subsequently, interested parties (such as developers and supervisors) can easily (and remotely) access the bug report and the corresponding recorded output signal to certify the bug report and to debug and (perhaps) fix the cause of the anomaly.

The above specification, examples and data provide a complete description of the manufacture and use of the composition of the invention. Since many embodiments of the invention can be made without departing from the spirit and scope of the invention, the invention resides in the claims hereinafter appended.

1. A computer-implemented method for digital recording-based computer testing, comprising:
testing at least one electronic device having an output signal that comprises information that reflects the state of the electronic device;
recording the output signal;
storing in a database the recorded output signal using keys that are sufficient to uniquely identify the recorded output signal;
receiving a bug report containing information about anomalies encountered while testing the electronic device and wherein the bug report contains information that is sufficient to uniquely identify the recorded output signal; and
associating in the database the bug report with the recorded output signal using information in the bug report to locate a particular recorded output signal that corresponds with the bug report.

2. The method of claim 1, wherein the output signal is for a video display.

3. The method of claim 1, wherein the output signal is from a camera that captures video of the electronic device.

4. The method of claim 1, further comprising compressing the recorded output signal.

5. The method of claim 1, wherein a plurality of output signals from a plurality of the electronic devices are simultaneously recorded.

6. The method of claim 1, further comprising remotely accessing the particular recorded output signal and associated bug report.

7. A computer-readable medium encoded with instructions for executing the computer-implemented method of claim 1.

8. A system for digital recording-based computer testing, comprising:
means for testing at least one electronic device having an output signal that comprises information that reflects the state of the electronic device;
means for recording the output signal;
means for storing in a database the recorded output signal using keys that are sufficient to uniquely identify the recorded output signal;
means for receiving a bug report containing information about anomalies encountered while testing the electronic device and wherein the bug report contains information that is sufficient to uniquely identify the recorded output signal; and
means for associating in the database the bug report with the recorded output signal using information in the bug report to locate a particular recorded output signal that corresponds with the bug report.

9. The system of claim 9, wherein the output signal is for a video display.

10. The system of claim 9, wherein the output signal is from a camera that captures video of the electronic device.

11. The system of claim 9, further comprising means for compressing the recorded output signal.

12. The system of claim 9, further comprising means for recording a plurality of output signals from a plurality of the electronic devices simultaneously.

13. The system of claim 9, further comprising means for remotely accessing the particular recorded output signal and associated bug report.

14. A digital recording-based computer testing system, comprising:
at least one electronic device under test having an output signal that comprises information that reflects the state of the electronic device;
a digital recording server that is configured to record the output signal;
a database that is configured to store the recorded output signal using keys that are sufficient to uniquely identify the recorded output signal; and
a workstation that is configured to:
receive a bug report containing information about anomalies encountered while testing the electronic device and wherein the bug report contains information that is sufficient to uniquely identify the recorded output signal; and
associate the bug report with the recorded output signal using the database and information in the bug report to locate a particular recorded output signal that corresponds with the bug report.

15. The system of claim 14, wherein the output signal is for a video display.

16. The system of claim 14, wherein the output signal is from a camera that captures video of the electronic device.

17. The system of claim 14, wherein the digital recording server is further configured to compress the recorded output signal.

18. The system of claim 14, wherein the digital recording server is further configured to record a plurality of output signals from a plurality of the electronic devices under test simultaneously.

19. The system of claim 14, further comprising a second workstation that is configured to remotely access the particular recorded output signal and corresponding bug report.
